(19) United States
(12) Patent Application Publication
(10) Pub. No.: US 2026/0171628 A1
(43) Pub. Date: Jun. 18, 2026

(54) FIXING STRUCTURE FOR ELECTRODE TABS OF BATTERY CELLS IN A POUCH CELL BATTERY

(71) Applicant: GUS TECHNOLOGY CO., LTD., Taoyuan City (TW)

(72) Inventors: CHUNG CHIEH CHANG, Taoyuan City (TW); HENG CHEN KUO, Taoyuan City (TW); MING HUEI TSAI, Taoyuan City (TW); CHIH HSING LEE, Taoyuan City (TW); CHING CHI CHENG, Taoyuan City (TW)

(21) Appl. No.: 18/977,916

(22) Filed: Dec. 12, 2024

(51) Int. Cl. H01M 50/54; H01M 50/211; H01M 50/507; H01M 50/516; H01M 50/533; H01M 50/588

(52) U.S. Cl. CPC H01M 50/54; H01M 50/211; H01M 50/507; H01M 50/516; H01M 50/533; H01M 50/588

(57) ABSTRACT

The present invention provides a fixing structure for electrode tabs of battery cells in a pouch cell battery, comprising two bus structures with a battery cell module positioned therebetween. Each bus structure includes a support seat and multiple busbars, with each busbar forming a joining surface. Multiple first electrode tabs of the battery cell module pass through the support seat and are bent to form first bent tab portions contacting the respective joining surfaces, while multiple second electrode tabs pass through the support seat and are bent to form second bent tab portions contacting the respective first bent tab portions. Each first bent tab portion is positioned between the corresponding joining surface and second bent tab portion, with the sequentially contacting busbar, first bent tab portion, and second bent tab portion being welded together.

### FIELD OF INVENTION

The present invention relates to a pouch cell battery and more particularly to a fixing structure for electrode tabs of battery cells in a pouch cell battery.

### BACKGROUND OF THE INVENTION

A pouch cell battery is a type of ion battery capable of storing and releasing significant amounts of electrical energy. Such batteries are widely used in automotive applications and energy storage systems. The ion battery types referred to herein include, but are not limited to, lithium-ion batteries.

A conventional pouch cell battery comprises a battery cell module, two bus structures, a protective case, and two electrodes. The battery cell module consists primarily of multiple battery cells arranged in parallel, each of which is used to store electrical energy. Each battery cell is equipped with two tabs which act as a positive or a negative pole. The bus structures are positioned at either end of the battery cell module, with each structure containing one or more busbars, and each tab is electrically connected to one adjacent busbar, allowing the battery cells to be interconnected in series or parallel via the tabs and the busbars. The protective case, typically made of metal, houses and secures the battery cell module while providing physical protection. Each electrode is electrically connected to one busbar and interfaces with external power transmission lines or electrical equipment. This configuration enables the battery cell module to supply power to external systems and facilitates the charging of the battery cells via the power transmission lines.

Each bus structure further includes a support seat, where the support seat is a plate-like structure made of an insulating material, and each busbar is a plate made of a conductive material. The support seat passes through multiple narrow elongated channels, one side of which faces the battery cell module and the other side of which is fixed with the busbars. Each sheet-like electrode tab passes through one of the channels and is bent to contact with the surface of the respective busbar and is welded to the respective contacting busbar.

Each electrode tab contacts the surface of the respective busbar on the side opposite the support seat. To accommodate the multiple electrode tabs, the entire busbars in each bus structure must be sufficiently wide in the thickness direction of the battery cell to allow the electrode tabs to be bent and sequentially spaced along the thickness direction to make contact with the respective busbars.

### SUMMARY OF THE INVENTION

The main purpose of the present invention is to provide a fixing structure for electrode tabs of battery cells in a pouch cell battery. In order to achieve this purpose, the present invention employs the following technical solution:

A fixing structure for electrode tabs of battery cells in a pouch cell battery, comprising two bus structures, wherein the pouch cell battery includes a battery cell module having multiple first battery cells and multiple second battery cells, each of the first and second battery cells having a thickness, a length, and a width, with the thickness direction of each first and second battery cell defined as a first direction, the length direction of each first battery cell defined as a second direction perpendicular to the first direction, and the width direction of each first battery cell defined as a third direction perpendicular to both the first and second directions, each first battery cell having two first electrode tabs acting as positive or negative electrodes positioned at both ends of the first battery cell along the second direction, each second battery cell having two second electrode tabs acting as positive or negative electrodes positioned at both ends of the second battery cell along the second direction, each first and second electrode tab being a sheet made of a conductive material and extending in the third direction to form a width; wherein
the bus structures are spaced apart along the second direction, with the battery cell module positioned therebetween;
each bus structure comprising a support seat and multiple busbars, each support seat being made of an insulating material and each busbar being a plate made of a conductive material, each support seat facing the battery cell module on one side in the second direction with each busbar connected to the support seat on the side opposite to the battery cell module in the second direction, each support seat having multiple first channels and second channels passing through in the second direction, each busbar forming a joining surface on the side opposite its connected support seat in the second direction;
each first electrode tab passes through one of the first channels and is bent along the first direction to form a first bent tab portion contacting the joining surface of the respective busbar, each second electrode tab passes through one of the second channels and is bent along the first direction to form a second bent tab portion contacting the respective first bent tab portion, and each first bent tab portion is positioned between the corresponding joining surface and second bent tab portion, with the sequentially contacting busbar, first bent tab portion, and second bent tab portion being welded and secured together in the second direction.

Each first bent tab portion overlaps with the respective second bent tab portion in the second direction and is welded to secure the first bent tab portion, the second bent tab portion, and the busbar together. This configuration facilitates the miniaturization of the pouch cell battery in the first direction.

### BRIEF DESCRIPTION OF THE DRAWINGS

FIG. 1 is a perspective view showing a pouch cell battery according to a preferred embodiment of the present invention;

FIG. 2 is an exploded perspective view of the pouch cell battery of the preferred embodiment;

FIG. 3 is an exploded perspective view showing the bus structure of the preferred embodiment;

FIG. 4 is a perspective view showing the support seat of the bus structure in the preferred embodiment;

FIG. 5 is a top view of the battery cell module, showing the state in which the first electrode tabs and second electrode tabs are bent to form first bent tab portions and second bent tab portions;

FIG. 6 is an enlarged partial view of FIG. 5, detailing the area marked as 6;

FIG. 7 is an enlarged partial view of FIG. 5, detailing the area marked as 7;

FIG. 8 is a schematic sectional view of the battery cell module in the preferred embodiment of the present invention; and

FIG. 9 is an enlarged partial view of FIG. 8, detailing the area marked as 9.

### DETAILED DESCRIPTION OF THE PREFERRED EMBODIMENTS

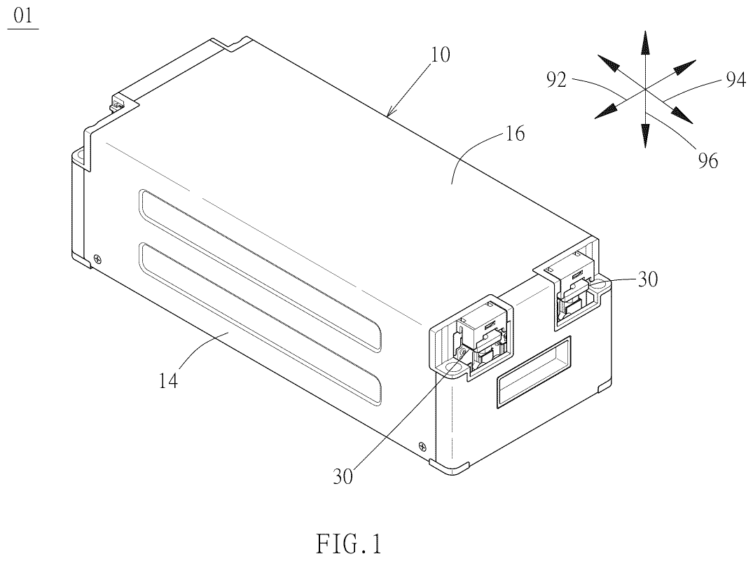

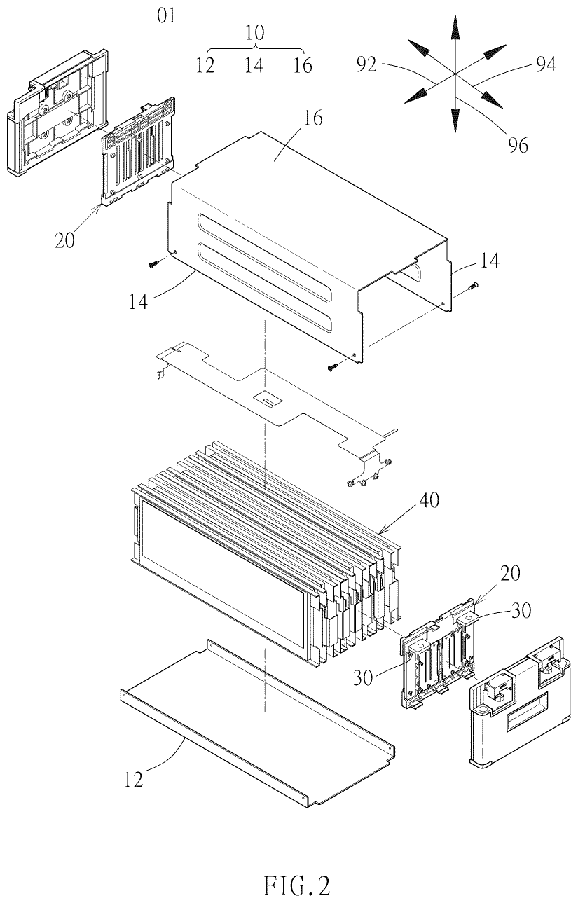

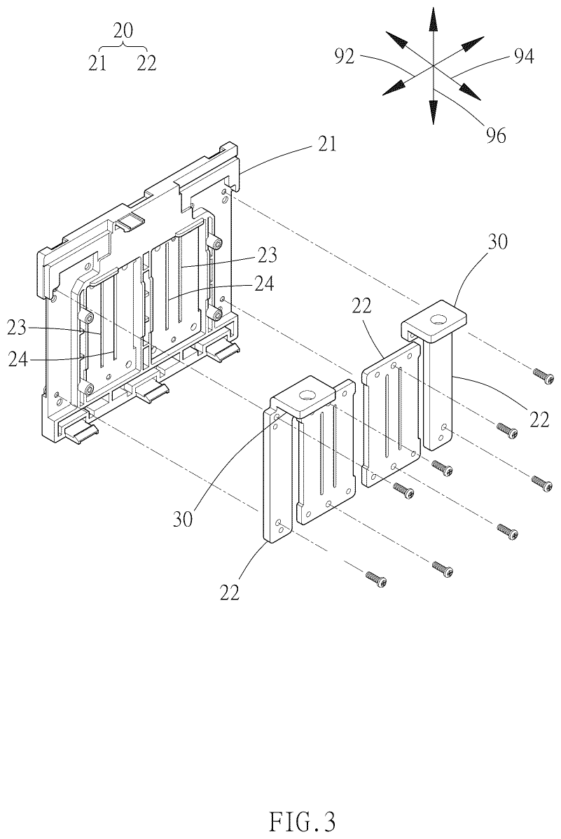

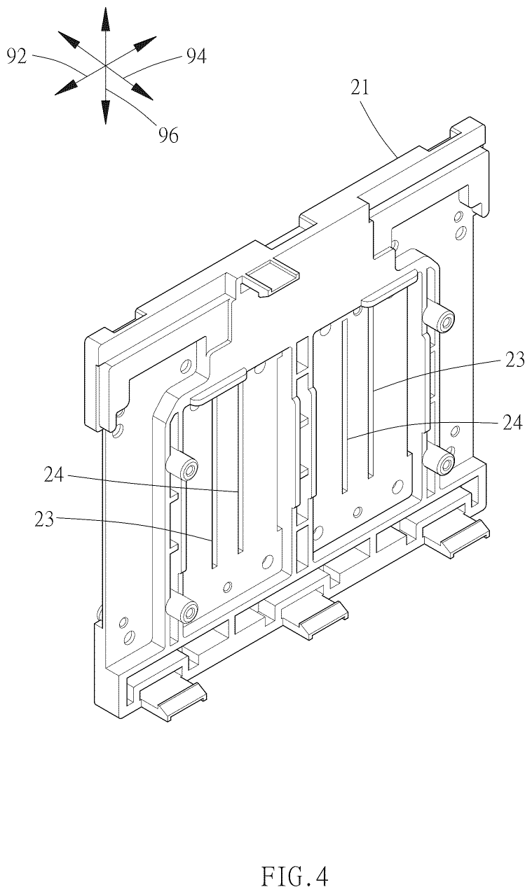

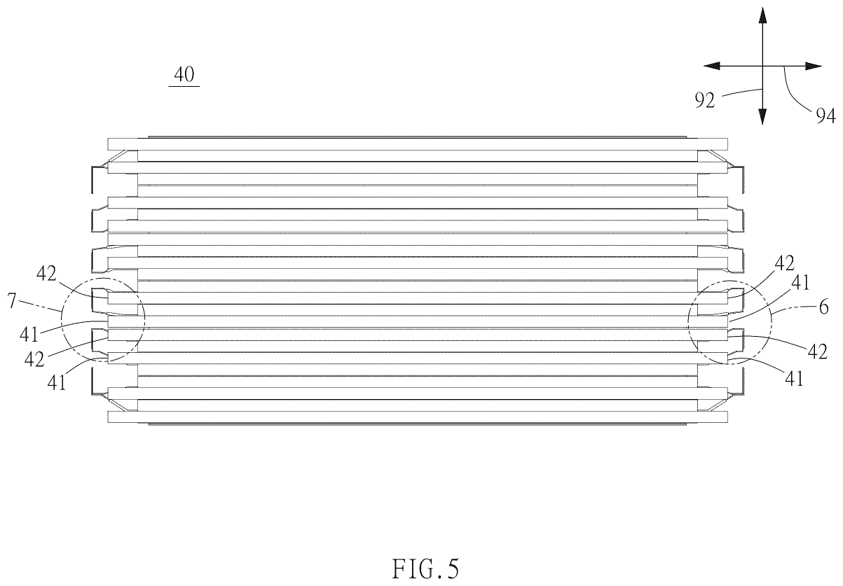

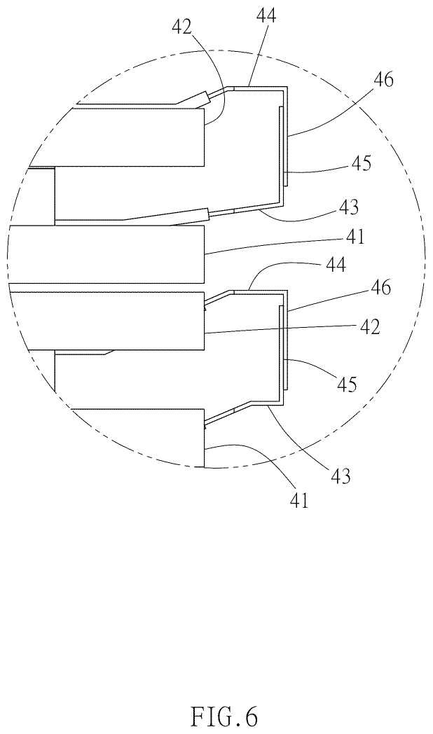

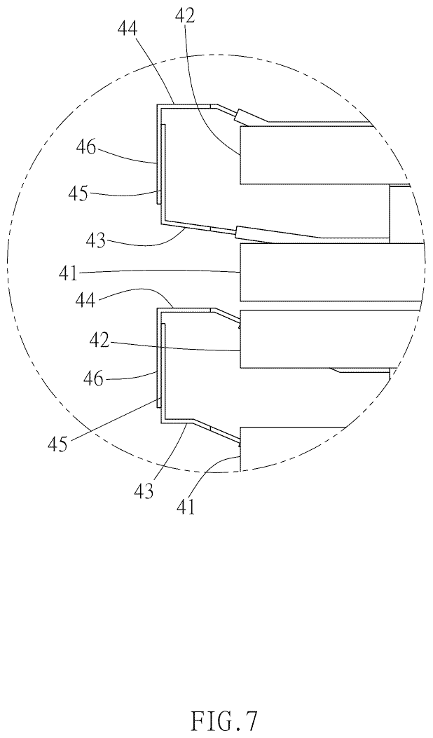

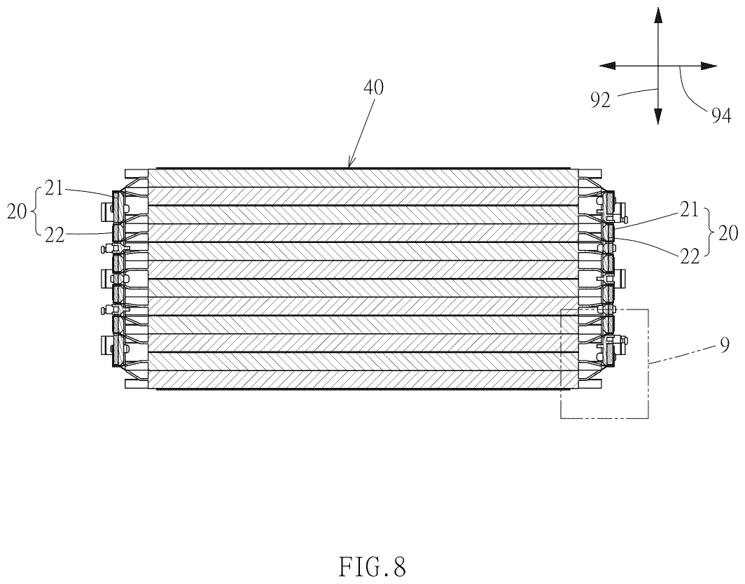

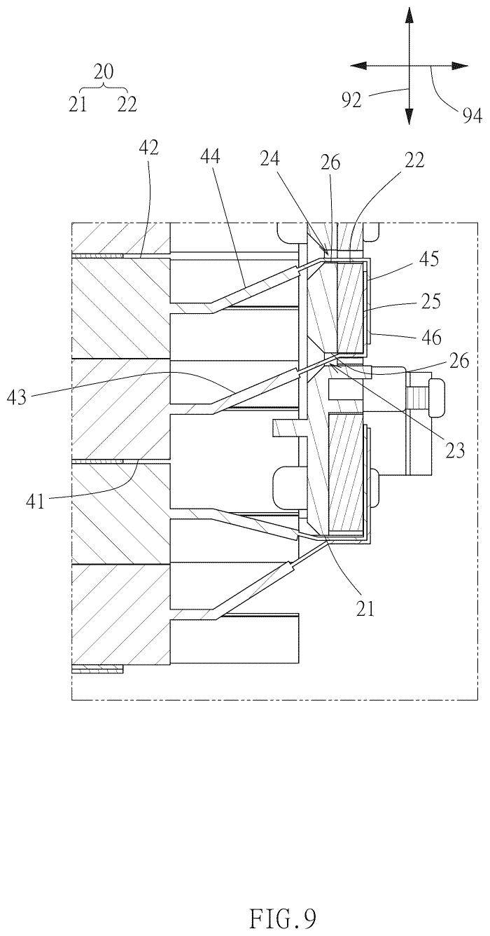

As shown in FIGS. 1 to 9, a preferred embodiment of the fixing structure for electrode tabs in a pouch cell battery of the present invention comprises two bus structures 20. The pouch cell battery 01 of this embodiment comprises a protective case 10, the bus structures 20, two electrodes 30, and a battery cell module 40. The protective case 10 is made primarily of metal and includes a bottom plate 12, two side plates 14, and a cover plate 16. The bottom plate 12 supports the battery cell module 40, while the side plates 14 are laterally opposed, and the cover plate 16 connects the side plates 14 which are further connected to the bottom plate 12. The battery cell module 40 is positioned between the side plates 14 and between the bottom plate 12 and the cover plate 16, with the protective case 10 providing physical protection for the battery cell module 40.

The battery cell module 40 includes multiple first battery cells 41 and second battery cells 42. Each first battery cell 41 and second battery cell 42 is defined by its thickness, length, and width. The thickness direction of each first and second battery cell 41, 42 is referred to as a first direction 92, while the length direction is referred to as a second direction 94. The first direction 92 is perpendicular to the second direction 94. The width direction of each first battery cell 41 is defined as a third direction 96, which is perpendicular to both the first direction 92 and the second direction 94. Each first battery cell 41 is equipped with two first electrode tabs 43, acting as either positive or negative electrodes and positioned at opposite ends of the first battery cell 41 along the second direction 94. Similarly, each second battery cell 42 is equipped with two second electrode tabs 44, acting as either positive or negative electrodes and positioned at opposite ends of the second battery cell 42 along the second direction 94. Both the first electrode tabs 43 and the second electrode tabs 44 are formed as sheets made of a conductive material and extend in the third direction 96 to form their width.

The bus structures 20 are spaced apart along the second direction 94 with the battery cell module 40 positioned therebetween.

Each bus structure 20 comprises a support seat 21 and multiple busbars 22. Each support seat 21 is made of an insulating material, while each busbar 22 is a plate made of a conductive material. Each support seat 21 is positioned adjacent to the battery cell module 40 on one side along the second direction 94, and each busbar 22 is connected to the support seat 21 on the opposite side along the second direction 94. Each support seat 21 includes multiple first channels 23 and second channels 24 that pass through in the second direction 94. Each busbar 22 forms a joining surface 25 located on the side opposite its connected support seat 21 in the second direction 94.

Each first electrode tab 43 passes through one of the first channels 23 and is bent along the first direction 92 to form a first bent tab portion 45. Each first bent tab portion 45 contacts the joining surface 25 of the respective busbar 22. Similarly, each second electrode tab 44 passes through one of the second channels 24 and is bent along the first direction 92 to form a second bent tab portion 46, with each second bent tab portion 46 contacting the respective first bent tab portion 45. Each first bent tab portion 45 is positioned between the respective joining surface 25 and second bent tab portion 46, and the sequentially contacting busbar 22, first bent tab portion 45, and second bent tab portion 46 are welded and secured together along the second direction 94.

Specifically, the first battery cells 41 and the second battery cells 42 are arranged along the first direction 92, with each first battery cell 41 positioned adjacent to the respective second battery cell 42 in the first direction 92, each first electrode tab 43 positioned adjacent to the respective second electrode tab 44 in the first direction 92, and each first bent tab portion 45 extending in an opposite direction and overlapping its adjacent contacting second bent tab portion 46 in the first direction 92, thereby enabling the first electrode tabs 43 and first bent tab portions 45, together with the adjacent second electrode tabs 44 and second bent tab portions 46, to form a wrap-around configuration with the connected busbars 22. This configuration enhances the bonding strength among the first electrode tabs 43, second electrode tabs 44, and busbars 22.

Each first bent tab portion 45 overlaps with the respective second bent tab portion 46 in the second direction 94 and is welded to secure the first bent tab portion 45, second bent tab portion 46, and busbar 22 together. To meet the electrical connection requirements of the battery cell module 40, the overall width required for all busbars 22 forming each bus structure 20 in the first direction 92 can be reduced compared to prior art. This reduction facilitates the miniaturization of the pouch cell battery 01 along the first direction 92.

Each first bent tab portion 45 extends in an opposite direction relative to its adjacent contacting second bent tab portion 46, such that the adjacent first electrode tabs 43 and second electrode tabs 44 form a clamping structure against their connected busbar 22 in the first direction 92, creating static friction between each first bent tab portion 45, its adjacent second bent tab portion 46, and the busbar 22, thereby improving the positional stability of the first and second bent tab portions 45, 46 along the first direction 92.

Each first electrode tab 43 and second electrode tab 44 abuts against a side wall 26 of its respective first channel 23 and second channel 24 along the first direction 92 of each support seat 21. This arrangement further enhances the positional stability of the first and second electrode tabs 43, 44 along the second direction 94.

What is claimed is:

1. A fixing structure for electrode tabs of battery cells in a pouch cell battery, comprising two bus structures, wherein the pouch cell battery includes a battery cell module having multiple first battery cells and multiple second battery cells, each of the first and second battery cells having a thickness, a length, and a width, with the thickness direction of each first and second battery cell defined as a first direction, the length direction of each first battery cell defined as a second direction perpendicular to the first direction, and the width direction of each first battery cell defined as a third direction perpendicular to both the first and second directions, each first battery cell having two first electrode tabs acting as positive or negative electrodes positioned at both ends of the first battery cell along the second direction, each second battery cell having two second electrode tabs acting as positive or negative electrodes positioned at both ends of the second battery cell along the second direction, each first and second electrode tab being a sheet made of a conductive material and extending in the third direction to form a width; wherein
the bus structures are spaced apart along the second direction, with the battery cell module positioned therebetween;
each bus structure comprising a support seat and multiple busbars, each support seat being made of an insulating material and each busbar being a plate made of a conductive material, each support seat facing the battery cell module on one side in the second direction with each busbar connected to the support seat on the side opposite to the battery cell module in the second direction, each support seat having multiple first channels and second channels passing through in the second direction, each busbar forming a joining surface on the side opposite its connected support seat in the second direction;
each first electrode tab passes through one of the first channels and is bent along the first direction to form a first bent tab portion contacting the joining surface of the respective busbar, each second electrode tab passes through one of the second channels and is bent along the first direction to form a second bent tab portion contacting the respective first bent tab portion, and each first bent tab portion is positioned between the corresponding joining surface and second bent tab portion, with the sequentially contacting busbar, first bent tab portion, and second bent tab portion being welded and secured together in the second direction.

2. The fixing structure according to claim 1, wherein each first electrode tab and second electrode tab abuts against a side wall of the respective first channel and second channel along the first direction of the support seat.

3. The fixing structure according to claim 1, wherein each first bent tab portion extends in an opposite direction and overlaps with its adjacent contacting second bent tab portion in the first direction.
